(19) United States
(12) Patent Application Publication
(10) Pub. No.: US 2007/0101630 A1
(43) Pub. Date: May 10, 2007

(54) Apparatus and method for framing

(75) Inventors: John Jones, London (GB); Matthew Jones, London (GB); Kristian Jones, London (GB)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: John Jones Art Centre Limited

(21) Appl. No.: 11/594,472

(22) Filed: Nov. 8, 2006

(30) Foreign Application Priority Data
Nov. 8, 2005 (GB) 0522721.0

(51) Int. Cl. B32B 27/30; B32B 27/32; B32B 29/00; A47G 1/06

(52) U.S. Cl. 40/794; 428/537.5; 428/522; 428/523

(57) ABSTRACT

A fillet for use in the framing industry, wherein the fillet includes a plastic body and a layer comprising an absorbent. The fillet prevents contamination of the artwork within the frame and increases the longevity and appeal of the art work.

### BACKGROUND OF THE INVENTION

1. Field of the Invention

This invention relates to a method and apparatus for framing works, generally artworks. It is particularly applicable, but by no means limited, to framing paper-based artwork to a high standard.

2. Description of the Related Art

Picture frames are used with photographs, drawings and many other mediums to perform two main functions. The first is to provide a visual link between the picture and the space in which it is to hang. The second is to protect and conserve the work, generally artwork.

The paper on which photographs and paintings are made will deteriorate over time. This affects the quality and ultimately the value of the work of art. Works on paper deteriorate with exposure to light, contamination and atmospheric pollution.

Many wooden frames contain turpines, benzenes and other contaminants. Over time, they discolor and ultimately destroy the paper within the frame. Artwork within the frame is usually hinged onto a board before being framed. This mounting board can also contribute to the destruction of the artwork if the correct museum quality grade isn't selected.

Furthermore, it is known for the artwork itself to contribute to its own destruction by turning acidic over time and releasing unwanted chemicals and contaminants.

When framing a picture, it is important to ensure that the paper of the picture does not come into contact with the glazing at the front of the frame. This glazing is typically glass or acrylic. If this happens, the picture can become stuck to the glass due to condensation, thus ruining it. It can also damage the medium used, i.e. pastels and charcoals from pressure or static electricity. In order to overcome this potential problem, frames usually include fillets of wood or mounting board which sit between the work and the glass, separating them from each other and ensuring that a gap is maintained between the glass and the picture. It has been found that the fillets themselves can also damage the picture. Furthermore, it has been discovered that the frame itself contributes to the destruction of the artwork.

Framing of quality pictures, paintings and photographs requires great skill to ensure longevity of the article. Standard framing is suitable for general everyday papers where conservation is not an issue but for more important articles the framing must be to a higher level. This is commonly known as conservation level framing. This level is sometimes not suitable for all items and consequently the highest grade museum quality framing materials must be used. Unfortunately, framing to this high level will still only slow down and not entirely prevent the deterioration and destruction of valuable works.

### BRIEF SUMMARY OF THE INVENTION

Accordingly, it is an object of the present invention to mitigate or overcome some or all of the problems outlined above.

A fillet for a frame wherein the fillet includes an absorbent, characterized in that a body of the fillet is made from a plastics material.

A picture frame incorporating a fillet wherein the fillet includes an absorbent and wherein the body of the fillet is made from plastics material.

A method of framing an item, comprising using a frame comprising a fillet, wherein the fillet comprises an absorbent and has a body comprising a plastics material.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 illustrates an exploded perspective view of a frame according to the present invention;

FIG. 2 illustrates a perspective view of a paper covered fillet according to the present invention; and

FIG. 3 shows an end view of a fillet according to the present invention.

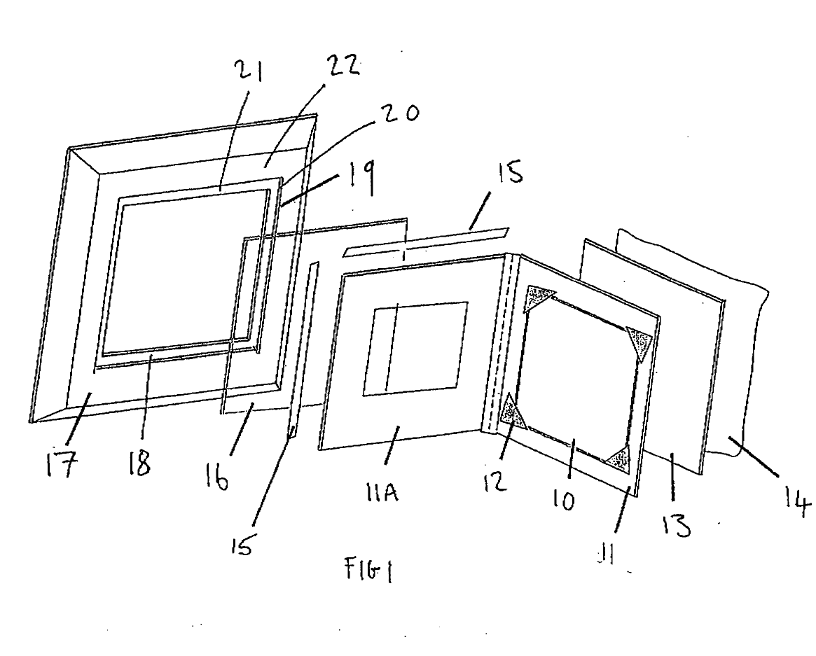

### DETAILED DESCRIPTION OF THE INVENTION

According to a first aspect of the present invention there is provided a fillet for a frame wherein the fillet includes an absorbent. Preferably the absorbent is provided within a layer. For the first time, this type of absorbent has been used specifically with fillets.

The term frame includes any article designed to house, mount or display an item, including artwork, photographs or any other item in any medium. The term frame can be replaced with the term picture frame. Generally, a frame, or picture frame, is made from wood or some other material and comprises a rectangular frame in which the item to be displayed is mounted. The frame has a backing board and some form of glazing in front of the item to protect it. The term picture is to be interpreted broadly and encompasses any item that it is desired to be displayed, including paintings, photographs, prints, drawings, writing, images or any other two-dimensional item. Furthermore, the term include ‘picture’ three-dimensional articles that are desired to be framed.

The term fillet is a standard term in the framing industry and takes this standard meaning. For reference, a fillet is a strip of material which is placed between the work and the glazing to stop them from coming into contact with each other. The size and shape of the material will depend on the use it is needed for. Generally, fillets of a rectangular (including square) cross section are used. This evenly distributes the pressure around the fillet and is a cost effective shape to manufacture. However, other shapes may be used and are encompassed by the present invention. The size of the fillet will depend on the size of the frame and/or the artwork to be protected. The size of the fillet will also be determined in part by the thickness of the glazing. Other varying factors include the depth of the side of the frame and the width of the inside face. Currently the most popular sizes are 5 mm×7 mm, 5 mm×10 mm, 5 mm×13 mm & 5 mm×16 mm.

Frames are generally rectangular and four strips of fillet are usually used along the four sides of the rectangle. These form a rectangle around the artwork to prevent it coming into contact with the frame. The shape of the frame will determine the configuration of the fillets in the frame. For example, if a round frame is used, the fillets may be designed to be curved so that they can effectively separate the artwork from the glazing.

The term fillet is intended to cover any item used to separate the artwork from the glazing when preparing a framed article. In general however, the fillet according to the present invention is a strip, preferably, plastic, generally rectangular, and of a size thickness to fit within a given frame type. However, it will be understood that the fillet can be made of other materials such as wood.

The absorbents to be used in the present invention include all known absorbents which are compatible with the items to be framed. The absorbents may absorb, adsorb or react and decompose a variety of impurities which are within the environment of the frame. The term absorbent and adsorbent can be used interchangeably depending on whether the contaminants enter the absorbing layer or adhere to the surface of the layer. For the avoidance of doubt, a layer that adsorbs contaminants on its surface is encompassed by the present invention and the definition of absorbents includes adsorbents.

In a preferred embodiment, the absorbent is an activated carbon or charcoal (including modified activated carbon) or similar carbon-containing absorbent materials, a molecular sieve, silica, silicate gel, activated alumina or mixtures and combinations thereof. Preferably, the absorbent is activated carbon, a modified activated carbon, a molecular sieve or a mixture thereof. Preferably, the modified activated carbon is activated carbon treated with copper or chromium.

Even more preferably, the molecular sieve is a zeolite. Zeolites are any one of a family of hydrous aluminum silicate minerals, whose molecules enclose among other things cations of sodium, potassium, calcium, strontium, or barium, or a corresponding synthetic compound. They are used chiefly as molecular filters and ion-exchange agents. The zeolites can trap and isolate unwanted molecules within the frame, for example, oxidizing agents, hydrogen sulfide (H₂S), hydrogen peroxide (H₂O₂), sulfuric acid (H₂SO₄), ozone (O₃), formaldehyde, nitrogen oxides (NO_{X}), chlorine (Cl₂), sulfur dioxide (SO₂), ketones, aldehydes, phenols and their associated acids. This helps to preserve the artwork and dramatically reduce the speed of deterioration.

Activated charcoal or carbon is essentially very porous carbon with a large surface area that can purify gases by adsorption and is also involved in solvent recovery, or deodorization.

The absorbent layer is excellent at removing acids, phenols, aldehydes, peroxides, ozone, sulfur dioxide, hydrogen sulphides and oxides of nitrogen, formaldehyde and ammonia from within the frame. These unwanted molecules are trapped within the layer and cannot attack the artwork. The absorbent layer absorbs at least some of the unwanted contaminants within the frame.

The term alkaline buffer includes all compounds which are capable of reducing or eliminating the effect of acidic components in an environment. The alkaline buffer includes all known alkaline materials which are compatible with the articles which are to be framed. The alkaline buffer may neutralize acids and other impurities which are in the environment of the frame. The acids may be present due to acidic material penetrating the frame, from materials within the frame including the fillet itself, the artwork, other materials within the frame and the frame itself.

In a preferred embodiment, the alkaline buffer is an alkaline earth carbonate or bicarbonate such as calcium carbonate, magnesium carbonate or magnesium bicarbonate. Zinc oxide or zinc carbonate may also be a suitable alkaline buffer. One or more alkaline buffers may be used in the layer, for example a combination of calcium carbonate, magnesium carbonate and zinc oxide.

Preferably, the alkaline buffer is also an absorbent. This can either add to the absorptive properties of the layer by having more absorptive material or can be used solely as the absorbent itself.

Microchamber papers and Microchamber museum mounting boards with their patented molecular trap technology have been proven to significantly outperform other mount boards in the protection of framed art.

These boards are available in 100% cotton rag manufactured by Nielsen & Bainbridge of Gainesboro, Tenn., USA, or from Conservation Resources International, LLC, Springfield Va. 22151, USA. The boards and papers contain zeolites which are molecular traps which collect airborne acidic pollutant gases. These harmful gases are the neutralized by an alkaline buffer of calcium carbonate. Therefore, within the micro environment of a sealed frame mounted with Microchamber the aging of artwork is considerably retarded.

The boards are substantially sulfur and lignin free, having a pH of 8.9 and pass the Photographic Activity Test. Microchamber boards are the only mount boards available that pass the ANSI IT 9.15 1992 for the blockage of acid/oxidizing gases.

According to a particularly preferred embodiment, the layer is a paper layer. Alternatively, the absorbent layer could be formed as part of the fillet itself in a 1-piece construction. Therefore, the present invention encompasses single piece fillets with an absorbent incorporated into it and also fillets comprising a separate layer associated with the fillet.

According to one example, the fillet is made from wood. Over time, the wood from the fillet itself can begin to produce unwanted contaminants. When this starts to happen, the absorptive layer absorbs these unwanted contaminants from the wood as well as unwanted contaminants from the air, and stops them affecting the artwork.

According to an alternative embodiment, the fillet is made from a plastic material. This overcomes the problems associated with wooden fillets and the absorptive layer is used to absorb at least some of the contaminants from the air.

There are various ways in which the fillet can be coated in the paper. One method includes mechanically slitting or cutting the paper to an accurate width to enable it to cover the substrate material (the fillet, preferably plastic). The paper is then wrapped around the (plastic) fillet and held in place with an adhesive. This can be achieved by using a polyurethane (PUR) hot melt glue system, where the glue is applied to the rear face of the paper. The glued paper can then be fed through a machine that subsequently mechanically wraps the paper around the shaped fillet. The paper can either meet on the underside of the fillet or a gap can be left between the two ends of the paper. Any gap can be covered by a suitable width of double sided tape, which ensures the finished product is suitably enclosed. The double-sided tape has a width less than the width of the fillet and is applied under pressure to ensure adhesion with the fillet. The finished product is then allowed to cure, preferably for 12-24 hours. The fillet can then be process cut to the desired length.

By using a strip of adhesive it is not necessary to use traditional holes with pins nailed into the frame. This eliminates traditional pin holes which can allow harmful gases to leak through and also the need for metal which can become oxidised any release further harmful contaminants.

An advantage associated with plastic fillets is that by covering the extruded plastic lengths before they are cut to smaller sizes means that it is far easier to cover the fillet with paper. Previously, wooden fillets were always shorter in length, which complicated paper wrapping. It is now possible to wrap extruded lengths of a few meters or more in a single wrap. This saves on manufacturing costs and ensures an even and reliable product.

The plastic fillet can be extruded in a long line and then cut to the desired size to fit a particular frame. The framer will make use of long lengths of fillet, cut to the desired size. In addition, standard sizes may be pre-cut for use with standard sized frames. This is an advantage over wooden fillets, which have to be made in pre-determined sizes.

One particular type of paper that can be used for the absorbent layer is called microchamber paper. However, the present invention encompasses any form of material that has the same physical and chemical effect as microchamber paper. The term microchamber paper encompasses any type of paper with absorptive properties and the terms microchamber and absorptive can be used interchangeably.

As stated above, for the first time, an absorbent layer has been used with a fillet. This absorbent layer is preferably a paper layer wrapped around the fillet. This sponge like material is placed within the frame to soak up at least some of the unwanted molecules and help preserve the artwork. An advantage of wrapping the fillet in this way is that the paper is automatically placed in the frame, near to the wooden sides of the frame, where many of the unwanted molecules originate. This way, the unwanted molecules are caught before they get a chance to circulate in the air within the frame. It also means that a framer will be adding significant benefits into the frame without having to add any further items or materials. In one step, the fillet prevents contact with the glazing, can be made from a plastics material which does not contribute to the degradation and actively absorbs unwanted molecules in the frame, thereby slowing down the whole degradation process. If the fillet is made from wood, any unwanted contaminants coming out of the wood are also caught.

Therefore, for the first time, there is provided a way of easily protecting the artwork from unwanted chemicals originating from the frame itself by placing an absorptive material in close proximity with the frame. This absorbs any unwanted molecules before they have a chance to circulate inside the frame cavity. The advantage of this system is that most framers do not want to add further materials into the frame process and by providing a fillet that achieves this aim without further work is a significant advance in the industry. This type of fillet would provide a primary defense against the frame itself and will help to prolong the life of the artwork. Most framers will not want to employ all of the techniques of museum grade framing and this is a good way for them to protect the work to a significant degree. The significant advantage is that the absorptive material is automatically placed in the best place in the frame to protect the work.

According to a second embodiment of the present invention there is provided a fillet for a picture frame wherein the fillet is made from a plastic material and is at least partially covered by a layer comprising paper.

Up to now, fillets have been made from either wood or chipboard. For the first time, a plastic fillet has been used which overcomes the problems associated with these materials. A plastic fillet does not contain any chemicals that can leach out and contaminate the work inside the frame. Because the work may be in permanent contact with the fillet, a plastic material will ensure that the fillet can be used for a long time without any danger of contamination. Wooden or board fillets may need to be periodically checked to ensure that they have not become acidic, damaging the work.

The fillet is also covered in paper. This has a number of advantages. The paper cover ensures that the fillets resemble the old, wooden ones. In a traditional industry, this is important. Furthermore, whilst the fillets are not generally visible once the framing has been completed, under certain circumstances the fillet may be visible and therefore the paper cover can improve the visual appearance of the fillet. It is also easier to color the paper to ensure it fits in with the rest of the frame than to specifically change the color of the plastic.

The use of a paper covered plastic fillet has not been used or considered in the framing trade before the present application.

A variety of plastic materials can be used in all embodiments of the present invention and will be selected by the materials specialist based on their suitability for conservation purposes. One preferred material is Perspex, a poly(methyl methacrylate), which is cheap to manufacture and does not affect the paper of the artwork. Other suitable plastics include, as well as other acrylic polymers, polypropylene, polyethylene and copolymers thereof.

According to a preferred embodiment the paper layer comprises the absorbent and/or alkaline buffer technology described above. For the first time, there is provided a plastic fillet which does not contribute to the contamination of the artwork and which is covered with an absorbent paper layer which absorbs at least some of the contaminants found within the frame.

Alternatively, the paper is acid free cotton paper. Using acid free cotton paper helps to ensure that the paper does not introduce any unwanted chemicals into the frame, particularly acids. Cotton fiber paper is naturally 100% Lignin, alum and acid free. Unlike wood pulp papers it does not require a buffering treatment to increase its alkalinity.

While absorptive paper is advantageous with the plastic fillets, it is not essential and plastic fillets wrapped in any form of paper are encompassed by embodiments of the present invention, for example cotton paper, wood pulp paper etc. The term paper is to be interpreted broadly and covers any fibrous sheet.

Preferably, the paper is attached to the fillet by an acrylic adhesive. In a preferred embodiment, the adhesive is a hot melt adhesive suitable for profile wrapping paper to the (plastics) fillet. It is essential the adhesive is acid free, and an adhesive that does not contaminate the artwork is necessary. Acrylic base is best as its bond strengthens over time.

Optionally, the fillet may be coated with an outer layer. This outer layer may be made from a plastics or other material. It can be formed as a lacquer on the outer surface of the fillet, for example the paper or the plastic itself. The lacquer helps to strengthen the paper and provides for a hardier fillet. When using absorptive paper, it is important for the unwanted molecules to be able to penetrate the lacquer and be absorbed.

Therefore, an outer (or further) layer should be chosen that does not stop the unwanted contaminants penetrating its surface and being absorbed by the absorbent layer below. However, it has been found that the further layer may break down over time. This means that a barrier can be chosen that does not immediately allow contaminants to pass through it. Initially, the further layer helps to keep the fillet in good condition before it is used within a frame and while the frame is being assembled. However, over time, the layer can break down sufficiently to allow contaminants to be absorbed. This has a number of advantages in that the absorptive powers of the layer are not compromised before the fillet is used in a frame. The outer layer can protect the fillet before use but not impede its application once it is in the frame.

It has been found experimentally that contaminants from a wooden fillet penetrate the paper (non-absorptive) and outer protective layer. Therefore, it can be summarized that the barrier does not prevent the contaminants from passing through and therefore the absorbent layer is not affected by the protective outer layer. This can be achieved in practice by either choosing a layer that allows contaminants to pass through or by breakdown of the barrier over time. It is theorized that the breakdown may be caused by the contaminant materials themselves therefore the fillet is self-activating.

According to one embodiment the fillet is made from an acrylic, preferably Perspex. Other preferred materials include Plexiglas, styrene and polycarbonates. The fillet can be a solid block of plastic, or can be hollow.

The present invention also includes a frame comprising a fillet as defined above. Preferably, the frame further comprises a backing board made from a plastic material, preferably polypropylene, polyethylene or a copolymer thereof. A suitable product is produced in the USA under the trade names Correx™ and Coroplast™.

Traditionally, the backing board was made from acidic MDF, chipboard or wood. The present invention provides for a plastic backing. This helps to reduce unwanted contaminants within the frame by introducing an inert material.

In addition, it has been found advantageous to use an absorptive layer as, in or with the mounting board. This provides additional protection for the artwork, as there is a greater surface area of paper to absorb pollutants. The mounting board then compliments the fillets. The fillets provide a good source of absorption by being placed close to the frame edge. The mounting board can also soak up further contaminants found within the frame cavity.

According to a particularly preferred embodiment, the inner sides of the frame are lined with a metal foil tape, or a metal foil paper covered tape. This tape was originally designed to be used at the back of the frame to hold the backing board in place. For the first time, it has been discovered that it is advantageous to line the inside of the frame with the tape. This provides an additional barrier between the wooden frame and the artwork and prevents or reduces gases from escaping the frame into the interior. Preferably the foil is an aluminum foil. More preferably it is adhesively-backed, suitably with and acrylic based glue. Other possible tapes include an aluminized polyethylene and/or nylon film barrier. Care needs to be taken with these tapes to ensure that an adhesive backing can be used.

As previously indicated, the cavity of the frame in which the artwork is placed (between the glazing and the mounting board) has the four internal sides (or inner surfaces) of the frame enclosing it. These internal sides are generally untreated wood and they leach unwanted contaminants into the cavity. For the first time, a system to reduce this contamination has been considered. By lining the internal side or inner surface with a tape, this contamination is at least reduced. Coupling this with a absorptive paper covered fillet helps to prevent any unwanted contaminants entering the cavity via the frame.

It will be appreciated that the present invention, as well as including a fillet for a picture frame, also includes a complete picture frame including such a fillet.

Therefore, according to a further embodiment of the present invention, there is provided a method of framing an item or article comprising the step of lining the inside edges of the frame. Preferably, a metal foil tape is used to line the inside edges and even more preferably, the metal foil tape is the same type of tape used at the back of the frame to hold the backing board in place.

The present invention also encompasses a method of framing an item including the step of introducing a fillet as described above into the frame, maintaining a gap between the glazing and the artwork. This has not been considered in the framing industry before the present invention.

Preferably, the method further includes the step of lining the inside edge of the frame with a metal foil tape. More preferably, the method further includes the step of introducing a plastic co-polymer backing board into the frame. Even more preferably, the method further includes the step of introducing a mounting board incorporating an absorptive material into the frame.

In summary therefore the present invention describes a fillet for a frame wherein the fillet includes an absorbent, characterised in that the body of the fillet is made from a plastics material.

Preferably the absorbent is provided within a layer, such as a layer of paper.

Preferably the absorbent includes an alkaline buffer, and more preferably the absorbent is selected from a group comprising activated carbon, a modified activated carbon, a molecular sieve or a mixture thereof.

A preferred molecular sieve is a zeolite.

Preferably the modified activated carbon is activated carbon treated with copper or chromium.

Preferably the alkaline buffer is selected from a group comprising calcium carbonate, magnesium carbonate, magnesium bicarbonate, zinc oxide, zinc carbonate or a mixture thereof, and more preferably the alkaline buffer is also an absorbent.

Preferably the alkaline buffer is provided within a layer.

In a particularly preferred embodiment the absorbent layer is a paper layer.

Preferably the fillet is made from an acrylic and advantageously the acrylic comprises poly(methyl methacrylate).

In an alternative embodiment the fillet is made from a polyolefin.

Preferably the fillet comprises a solid plastic fillet.

Preferably the fillet is made from a plastic material and is at least partially covered by a layer comprising paper.

Preferably the paper is acid free cotton paper, and preferably the paper layer further comprises an absorbent.

Preferably the paper layer further comprises an alkaline buffer.

Preferably the paper layer is attached to the fillet by an adhesive.

Preferably the fillet is coated with a further outer layer or lacquer which is advantageously a plastic layer.

The invention also describes a picture frame incorporating a fillet as herein described.

Preferably the frame further comprises a backing board made from a plastic material. More preferably the inside edges of the frame are lined with metal foil tape.

Also described is a method of framing an item, wherein a fillet as described and claimed herein is used.

Preferably the fillet is attached to the frame by means of an adhesive.

Preferably the method includes the further step of lining the inside edges of the frame with a metal foil tape.

Preferably the method includes the further step of introducing a plastic backing board into the frame.

Preferably the method includes the further step of introducing a mounting board incorporating an absorbent.

The present invention is applicable, but in no way limited to, the framing of any articles. These include articles made from paper, photographs, sketches, paintings, drawings, images, 3 dimensional objects or any other material that can be framed.

Embodiments of the invention will now be described, by way of example, and with reference to the drawings.

The present embodiments represent the best ways known to the applicant of putting the invention into practice. However they are not the only ways in which this can be achieved.

The artwork 10 is held on a mount backing 11 by tabs 12. In this instance, the mount is hinged so that the artwork is sandwiched between the mount. A mount front 11A, hingedly mounted to the mount backing 11, can be brought into contact with the edge of the artwork. The mount is placed on a moisture control material 13, which is supported with a chemically inert backing board.

In front of the artwork are fillets 15. In this instance, four individual fillets are used to keep the artwork 10 and mount 11 away from the glazing 16. Only two of the four fillets are shown for clarity. This prevents the glazing coming into contact with the artwork. Were this to happen, the artwork is likely to become fused to the glazing.

These layers are then put into the frame 17. It can be seen that the layers are configured to fit exactly within the back of the frame where a recess 18 is provided. A foil tape 19 is placed around the inwardly facing edge 20 of the recessed part of the frame to prevent contaminants from the wood of the frame coming into contact with the artwork. The foil provides a barrier along the inner edge of the frame where it would otherwise be open to the area between the glazing and the backing board where the artwork is positioned.

The foil can also line, either completely or only partially, the rearward facing surfaces 21 and/or 22 of the frame. This helps to ensure that all of inwardly facing surface 20 is lined or covered.

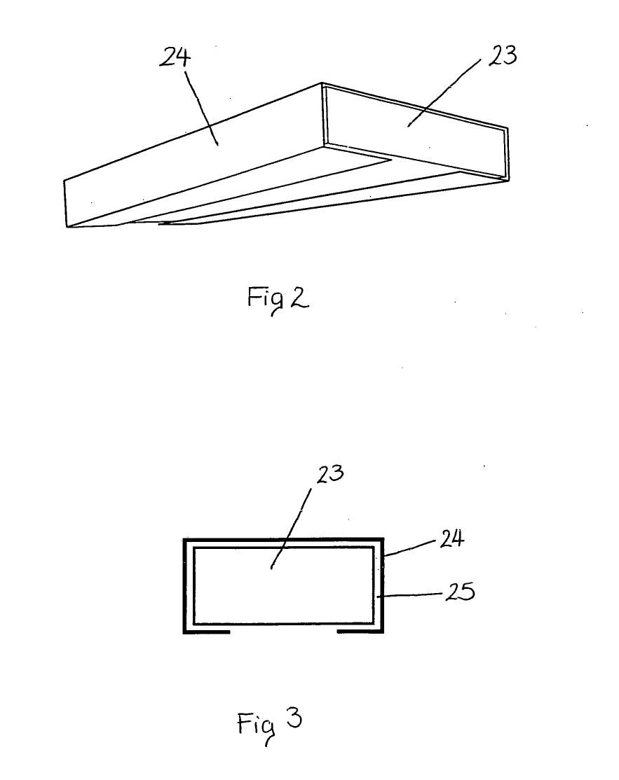

FIG. 2 shows a perspective view of the fillet 15. The body of the fillet is made up of a length of plastic 23, which is covered with absorptive paper 24. A suitable form of paper or foil is supplied by BauschLinnemann of Sassenberg, Germany under the trade mark TECOFOIL S®. The paper is attached to the plastic body by means of an adhesive 25, shown in FIG. 3. The paper is mechanically slit or cut to an accurate width to enable it to cover the substrate material (the plastic fillet). The paper is then wrapped around the plastic body and held in place with an adhesive. This can be achieved by using a polyurethane (PUR) hot melt glue system where the glue is applied to the rear face of the paper. The glued paper can then be fed through a machine that subsequently mechanically wraps the paper around the shaped fillet. The paper can either meet on the underside of the fillet or a gap can be left between the two ends of the paper. Any gap can be covered by a suitable width of double sided tape, which ensures the finished product is suitably enclosed. The double sided tape has a width less than the width of the fillet and is applied under pressure to ensure adhesion with the fillet. The finished product is then allowed to cure, preferably for 12-24 hours. The fillet can then be process cut to the desired length.

It can be seen that a gap is left between the underside edges of the paper covering. The paper can either cover the whole fillet or not, leaving a gap. Because the adhesive is placed over this gap, it is not visible in use. Furthermore, the absorptive paper will not be effective as it is covered by the adhesive therefore it is not necessary to cover this part of the fillet with paper. Finally, the adhesive can form a better bond if it is applied directly to the plastic material.

The present invention encompasses a fillet including a layer comprising an absorbent. It also encompasses a paper covered plastic fillet. It further encompasses particular uses of absorbent paper in the framing industry, and more particularly using absorbent paper covered fillets. The present invention also encompasses the use of foil linings on the inside of the frame to prevent contaminants escaping the wood into the artwork. Furthermore, the present invention encompasses the use of a plastic backing board. These inventions can either be used together or separately. Each individually has advantages over the prior art and they combine to produce a forward step in the delivery of quality framing.

1. A fillet for a frame wherein the fillet includes an absorbent, characterized in that a body of the fillet is made from a plastics material.

2. A fillet according to claim 1 wherein the absorbent is provided within a layer.

3. A fillet according to claim 2 wherein the layer is a paper layer.

4. A fillet according to claim 1 wherein the absorbent includes an alkaline buffer selected from a group comprising calcium carbonate, magnesium carbonate, magnesium bicarbonate, zinc oxide, zinc carbonate or a mixture thereof.

5. A fillet according to claim 4 wherein the alkaline buffer is also an absorbent.

6. A fillet according to claim 4 wherein the alkaline buffer is provided within a layer.

7. A fillet according to claim 1 wherein the absorbent is selected from a group comprising activated carbon, a modified activated carbon, a molecular sieve or a mixture thereof.

8. A fillet according to claim 1 wherein the fillet is made from a plastic selected from an acrylic and a polyolefin.

9. A fillet according to claim 8 wherein the acrylic comprises poly(methyl methacrylate).

10. A fillet according to claim 8 wherein the fillet comprises a solid plastic fillet.

11. A fillet according to claim 1 wherein the fillet is made from a plastic material and is at least partially covered by a layer comprising paper.

12. A fillet according to claim 11 wherein the paper layer further comprises an absorbent.

13. A fillet according to claim 11 wherein the paper layer further comprises an alkaline buffer.

14. A fillet according to claim 11 wherein the paper layer is attached to the fillet by an adhesive.

15. A fillet according to claim 11 wherein the fillet is coated with a further plastic outer layer or lacquer.

16. A picture frame incorporating a fillet wherein the fillet includes an absorbent and wherein the body of the fillet is made from plastics material.

17. A picture frame as claimed in claim 16 wherein the frame further comprises a backing board made from a plastics material and inside edges of the frame are lined with metal foil tape.

18. A method of framing an item, comprising using a frame comprising a fillet, wherein the fillet comprises an absorbent and has a body comprising a plastics material.

19. A method according to claim 18, further comprising the steps of lining inside edges of the frame with a metal foil tape and introducing a plastic backing board into the frame.

20. A method according to claim 18, further comprising the step of introducing a mounting board incorporating an absorbent.
